(19) United States
(12) Patent Application Publication
(10) Pub. No.: US 2013/0253940 A1
(43) Pub. Date: Sep. 26, 2013

(54) SYSTEM AND METHOD FOR DIAGNOSIS INVOLVING CROWDSOURCING

(71) Applicant: Aloysious Zziwa, Kampala (UG)

(72) Inventor: Aloysious Zziwa, Kampala (UG)

(73) Assignee: ZILLA COLLECTIONS LLC, Wilmington, DE (US)

(21) Appl. No.: 13/425,009

(22) Filed: Mar. 20, 2012

(51) Int. Cl. G06N 5/02; G06Q 50/22

(52) U.S. Cl. 705/2; 706/47

(57) ABSTRACT

A system and method for diagnosing a condition or problem (including but not limited to health-related conditions) includes at least one computing device configured to perform steps including collecting and storing electronic data from a search user seeking to obtain diagnosis, applying stored diagnosis rules to the electronic data to identify possible diagnoses each having an associated diagnosis rule trust factor and based on information received from expert users and non-preselected contributing users, and communicating multiple of possible diagnoses based at least in part on diagnosis rule trust factors. User feedback and data mining applied to search data may also be used to help a learning engine improve diagnosis results over time.

### TECHNICAL FIELD

Subject matter described herein relates to diagnosis of conditions or problems (e.g., pertaining to health, machines, systems, or activities) utilizing a communication network including communication between multiple individuals. Diagnosis of conditions or problems relating to various technical fields is contemplated, including but not limited to conditions or problems relating to disease and health care.

### BACKGROUND

Formal diagnosis of conditions or problems (e.g., pertaining to health, machines, systems, or activities) is often performed by professionals trained in one or more relevant technical or academic fields. It can be time-consuming and/or expensive to obtain professional diagnosis of conditions or problems, and the resulting diagnosis may or may not be accurate.

In the healthcare field, medical diagnosis has been identified as accounting for about 10 percent of all medical costs—with diagnostic costs estimated to account for approximately $250 billion per year in the United States alone. The costs of delayed and/or inaccurate diagnosis are also substantial, both in terms of economic loss and in human suffering.

As more patients take active roles in their healthcare and decision-making, many are becoming experts in their disease and condition diagnoses—sometimes even more so than the professionals who are paid to provide medical care. One of the ways that patients develop expanded expertise is through patient communities. Patient communities may include patients, service providers, and (occasionally) medical researchers who find one another and interact online, such as by comparing notes, reviewing caregivers, and exchanging knowledge regarding symptoms, treatment options, and resources. Most patient communities are focused on specific chronic, genetic, rare, or terminal diseases or conditions.

Although patient communities can assist participants in identifying symptoms, the disease- or condition-specific nature of most patient communities renders them of greatest value to participants already diagnosed with a disease or condition. A patient community is typically of much more limited value to people who seek diagnosis but lack knowledge of the specific disease or condition that is the focus of the patient community.

U.S. Pat. No. 7,814,035 to Mundie, et al. and entitled “Large-Scale Information Collection and Mining” discloses an online system to facilitate data analysis including means for obtaining medical data (i.e., anonymous data) regarding an unselected population from multiple sources via the Internet, and use of one or more statistical, data-mining, machine-learning or artificial intelligence algorithms to draw at least one conclusion from the medical data. A machine learning algorithm mines data by according different weights to different data, with greater weight being accorded assigned to data that is deemed more likely to be accurate. The disclosed system has limited utility in enabling patients to interact with others to improve diagnosis of diseases or medical conditions.

U.S. Patent Application Publication No. 2003/0093301 to Levine and entitled “Methods and Systems for the Creation and Use of Medical Information” discloses a system that generates and uses electronic medical information about patients, with the system including a set of predetermined rules that are used to automatically analyze electronic medical records in light of a matrix of predefined medical conditions and correlate a specific medical record with one or more medical conditions in the medical conditions matrix. The analytical rules and medical conditions matrix may be created and maintained by an advisory board of (medical) network professionals. The disclosed system relies upon automatic data analysis and has limited utility in enabling patients to interact with others (including non-experts) to improve diagnosis of diseases or medical conditions.

It would be desirable to reduce the cost, increase the accuracy, and increase the convenience of diagnosing conditions or problems. It would be desirable to incentivize individuals (including individuals having varied experiences and various levels of professional training or a lack thereof) to assist in diagnosing conditions or problems. It would be desirable to facilitate trust and promote business relationships between people seeking diagnosis of conditions or problems and professional service providers capable of addressing or curing such conditions or problems. It would also be desirable to enable identification of disease outbreaks that may be geographically and/or temporally localized before patients even go to hospital emergency rooms. Various aspects of the present invention address one or more of the foregoing issues.

### SUMMARY

The present invention relates in various aspects to systems and methods for diagnosing conditions or problems including use of a communication interface and a computing platform or control module.

In one aspect, the invention relates to a system for diagnosing a condition or problem, the system comprising: a communication interface for sending and receiving network messages; and a control module coupled with the communication interface configured to: (a) collect and store electronic data from a search user seeking to obtain diagnosis of the condition or problem, wherein the electronic data includes information indicative of at least one symptom relating to the condition or problem and includes information indicative of geographic region or location of the search user; (b) apply stored diagnosis rules to the electronic data to identify at least one possible diagnosis of the condition or problem, wherein the stored diagnosis rules includes diagnosis rules generated from information contributed by any of (i) expert users and (ii) non-preselected contributing users, and wherein each diagnosis rule has associated therewith a diagnosis rule trust factor; and (c) communicate to the search user the identified at least one possible diagnosis of the condition or problem.

In another aspect, the invention relates to a method for diagnosing a condition or problem, method comprising utilizing at least one computing device that includes at least one processor and at least one memory element, to perform steps comprising: (a) collecting and storing electronic data from a search user seeking to obtain diagnosis of the condition or problem, wherein the electronic data includes information indicative of at least one symptom relating to the condition or problem and includes information indicative of geographic region or location of the search user; (b) applying stored diagnosis rules to the electronic data to identify at least one possible diagnosis of the condition or problem, wherein the stored diagnosis rules includes diagnosis rules generated from information contributed by any of (i) expert users and (ii) non-preselected contributing users, and wherein each diagnosis rule has associated therewith a diagnosis rule trust factor; and (c) communicating to the search user the identified at least one possible diagnosis of the condition or problem.

In another aspect, the invention relates to a method for diagnosing a condition or problem, method comprising utilizing at least one computing device that includes at least one processor and at least one memory element, to perform steps comprising: (a) collecting and storing electronic data from a search user seeking to obtain diagnosis of the condition or problem, wherein the electronic data includes information indicative of at least one symptom relating to the condition or problem and includes information indicative of geographic region or location of the search user; (b) applying stored diagnosis rules to the electronic data to identify a plurality of possible diagnoses of the condition or problem, wherein each diagnosis rule has associated therewith a diagnosis rule trust factor; and (c) communicating to the search user the plurality of possible diagnoses of the condition or problem, wherein such identifying includes ranking the possible diagnoses based at least in part on diagnosis rule trust factors associated with the diagnosis rules used to identify the respective possible diagnoses.

In yet another aspect, the invention relates to a method for diagnosing a condition or problem, method comprising utilizing at least one computing device that includes at least one processor and at least one memory element, to perform steps comprising: (a) collecting and storing electronic data from a search user seeking to obtain diagnosis of the condition or problem, wherein the electronic data includes at least one identified symptom relating the condition or problem and at least one identifier indicative of geographic region or location of the search user, wherein the collecting comprises use of a graphical user interface associated with a computing device, and wherein the storing comprises storage of collected electronic data transmitted via an electronic communication network; (b) applying diagnosis rules to the electronic data to identify at least one possible diagnosis of the condition or problem, wherein the diagnosis rules include associated rule trust factors; (c) eliciting feedback from the search user seeking to obtain diagnosis of the condition or problem, wherein said feedback is indicative of accuracy of the at least one possible diagnosis; and (d) adjusting at least one rule trust factor based on feedback from the user, and storing the adjusted at least one rule trust factor in the at least one memory element.

In still another aspect, the invention relates to a method for promoting diagnosing a condition or problem, method comprising utilizing at least one computing device that includes at least one processor and at least one memory element, to perform steps comprising: (a) receiving user information from an expert user candidate and electronically storing the user information in the at least one memory element; (b) verifying user information received from the expert user candidate in order to validate the expert user candidate as an expert user; (c) assigning an expert user trust factor to the expert user; and (d) updating the expert user trust factor based upon at least one of the following: (i) receipt of ratings of the expert user generated by search users seeking diagnosis of conditions or problems; and (ii) confirmation of validity of diagnosis rules generated from information contributed by the expert user, wherein said diagnosis rules are useable to automatically diagnose a condition or problem based upon information received from a search user including information indicative of at least one symptom relating to the condition or problem and including information indicative of geographic region or location of the search user

As used herein, the terms “function,” “engine,” or “module” refer to hardware, firmware, or software in combination with hardware and/or firmware, for implementing features described herein. For example, subject matter described herein may be implemented in software executed by one or more processors. In one exemplary implementation, the subject matter described herein may be implemented using a non-transitory computer readable medium having stored thereon computer executable instructions that when executed by the processor of a computing device control the computing device to perform steps. Exemplary computer readable media suitable for implementing the subject matter described herein include non-transitory computer readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

In another aspect, any of the foregoing aspects, and/or various separate aspects and features as described herein, may be combined for additional advantage.

In at least certain embodiments, a condition or problem to be diagnosed includes at least one of a medical condition, a disease, a drug interaction, and a drug side effect, although it is to be understood that the invention is not necessarily restricted in scope to the foregoing context.

Other aspects, features and embodiments of the invention will be more fully apparent from the ensuing disclosure and appended claims.

### BRIEF DESCRIPTION OF THE DRAWINGS

FIG. 1 is a system interconnection diagram illustrating connections between various elements of a system for diagnosing a condition or problem including use of a control module and a communication interface (e.g., an electronic communication network).

FIG. 2 is a flowchart identifying various steps of a method for diagnosing a condition or problem including use of a communication interface and a control module including a learning engine.

FIG. 3 is a flowchart identifying various steps of a method for establishing and/or altering user trust factors that may be used in a system and method for diagnosing a condition or problem including use of a communication interface and a control module.

FIG. 4 is a flowchart identifying various steps of a method for reviewing and evaluating provisional diagnosis rules for possible validation and inclusion in a live database that may be used in a system and method for diagnosing a condition or problem including use of an electronic communication interface and a control module.

FIG. 5 is a flowchart identifying various steps of a method for modifying disease descriptions and/or symptoms that may be used in a system and method for diagnosing a condition or problem including use of a communication interface and a control module.

FIG. 6 is a flowchart identifying various steps of a method for coordinating in-person interaction between a user seeking diagnosis of a problem or condition and an expert to promote diagnosis of the problem or condition, and for eliciting feedback from the user seeking diagnosis to permit updating of a learning engine associated with a system and method for diagnosing a condition or problem including use of a communication interface and a control module.

FIG. 7 is an image of a first user interface screen for accessing a Web-based system for diagnosis of medical conditions or problems, the first user interface screen including a dialog box permitting search and/or entry of symptoms.

FIG. 8 is an image of a second user interface screen for accessing a Web-based system for diagnosis of medical conditions or problems, the second user interface screen including a listing of symptoms entered by a user and searched so far, a listing of suggested symptoms, and identification of multiple possible diagnoses ranked according to probability of each respective diagnosis corresponding to the searched symptoms.

FIG. 9 is an image of a third user interface screen for accessing a Web-based system for diagnosis of medical conditions or problems, the third user interface screen including a description of one possible diagnosis identified in FIG. 8 as selected by the user, with identification of contributors and references corresponding to the description and/or associated diagnosis rule, and including a dialog box eliciting feedback from the user as to the correctness of the selected possible diagnosis.

FIG. 10 is an image of a fourth user interface screen for accessing a Web-based system for diagnosis of medical conditions or problems, the fourth user interface screen eliciting further input from the user following receipt of user feedback that the user did not perceive a previously presented possible diagnosis as being correct.

### DETAILED DESCRIPTION

The present invention relates in various aspects to systems and methods for diagnosing conditions or problems including use of a communication interface and a control module (e.g., computing platform). Although certain embodiments as disclosed herein related specifically to healthcare (including diagnosis of medical conditions), it is to be understood that the invention is not limited to medical diagnosis or healthcare applications. Instead, the invention according to various embodiments relates to diagnosis of conditions or problems pertaining to numerous contexts, such as (but not limited to) health, machines, systems, or activities.

Systems and methods as described herein are preferably implemented via one or more communication networks, preferably including the Internet, but also preferably extending to other networks such as wired and wireless telephone networks, intranets, satellite networks, and other networks of any suitable type. Suitable networks preferably permit transmission of electronic data, images, and/or sounds.

In certain embodiments, systems and methods according to the invention benefit from diagnosis by crowd-sourcing, including contributions from expert users, non-preselected contributing users, and search users. Certain non-expert users may be anonymous. Using contributions from and tracking activity of this “crowd,” a learning diagnosis engine may be used to dynamically update diagnosis rules and symptom descriptions, thereby permitting diagnosis results with continuous improvement in accuracy to be obtained the longer the system is in use. By including contributions of expert users, but also taking into account contributions of non-preselected contributing users, diagnosis systems and methods benefit from a substantially larger pool of contributor experiences than frameworks relying solely on expert contributions for diagnosis. User feedback and data mining applied to search data may also be used to help a learning engine improve diagnosis results over time. User trust factors and diagnosis rule trust factors may be used during search and learning processes to determine whether certain information should be accorded greater weight than other information.

Various embodiments as disclosed herein are intended to provide alternative means for diagnosis of conditions or problems without resorting first to direct consultation with a diagnosis and/or treatment professional. Search users, contributing users, and expert users are contemplated.

In certain embodiments, search users include individuals searching for diagnoses of conditions or problems. A search user may communicate via a communication interface with a control module that (a) receives electronic data from the search user (e.g., information indicative of at least one symptom relating to the condition or problem, and information indicative of geographic region or location of the search user), (b) applies stored diagnosis rules to the electronic data to identify at least one possible diagnosis of the condition or problem, and (c) communicates to the search user the at least one possible diagnosis. In certain embodiments, search users may be anonymous, but preferably provide to a system administrator sufficient information (e.g., username, password, and communication details such as email address or telephone number) to enable communication with the search user, storage of search information associated with the search user, and storage of diagnosis results associated with the search user.

In certain embodiments, contributing users may include non-experts (e.g., informed amateurs) seeking to assist in diagnosis of conditions or problems and/or seeking to learn more about symptoms of conditions or problems and their diagnoses. Contributing users may be anonymous or otherwise identified to third parties, but preferably provide to a system administrator at least enough information to enable communication with the contributing user, and storage of contributions associated with the search user. In certain embodiments, contributing users may constitute a subset of search users. In certain embodiments, a search user may be automatically deemed a contributing user after providing at least one contribution of information.

In certain embodiments, expert users may include (a) professionals (e.g., recipients of formal training) normally engaged in diagnosis and/or treatment (or mitigation) of conditions or problems; and/or (b) researchers or academics having formal training or research experience in the relevant technical area. Expert users are preferably identifiable to third parties. In certain embodiments, an expert candidate may provide a system administrator with identifying information sufficient to identify the expert and the expert's qualifications, with the candidate preferably providing contact information to enable the candidate to be contacted by search users (whether directly, or indirectly through the system administrator). Expert candidate information may be subject to validation (e.g., by contacting professional licensing boards, government authorities, trade groups, other experts, investigatory organizations, or other relevant institutions) by an expert validation tool (e.g., implemented in hardware and software) and/or by a system administrator before an expert candidate is approved as an expert user.

In certain embodiments, users are assigned user trust factors that are subject to change based on usage of and interaction with the system. Mere search users may have a low user trust factor; contributing users may have a relative higher user trust factor that improves with performance (e.g., based on how many times the contributing user's prior diagnosis or contributed information was correct); and expert users may have the highest trust factors. Expert user trust factors may change based on the accuracy or value of the expert user's contributions, accuracy history of the expert user's diagnoses, and ratings of expert users by other users.

In certain embodiments, expert users and contributing users are able to contribute information that may be used to suggest diagnosis rules and/or symptoms, which may be subject to evaluation and/or modification by other users. A diagnosis rule may include a logical link (e.g., Boolean logic) between a diagnostic conclusion and presence of one or more symptoms (or presence of one or more symptoms in the absence of one or more other symptoms). Each diagnosis rule preferably has an associated rule trust factor.

Upon establishment of a new diagnosis rule, the new diagnosis rule may be assigned a diagnosis rule trust factor based on a user trust factor of the user contributing the new diagnosis rule. If the user trust factor of the user contributing the new diagnosis rule is sufficiently high (e.g., if the user contributing the new rule is an expert user), or if the rule trust factor is elevated to a sufficient level, then the diagnosis rule may be stored in a “live” diagnosis rule database and be eligible for application to electronic data entered by search users to diagnose a condition or problem. Conversely, if a new diagnosis rule does not have a sufficiently high diagnosis rule trust factor, then the new diagnosis rule may be stored in a provisional diagnosis rule database (or otherwise identified as a provisional diagnosis rule), and not yet be eligible for live use. A diagnosis rule may retain a provisional diagnosis rule status until it is promoted to confirmed diagnosis rule status, or otherwise removed from the provisional diagnosis rule database. Various methods for promotion of a provisional diagnosis rule to a confirmed diagnosis rule include, but are not limited to, validation or seconding by a different user having a sufficiently high user trust factor (e.g., an expert user), and validation through application of learned methodologies by the learning engine.

In certain embodiments, expert users and contributing users are able to modify problem or condition information and symptom information in wiki format (e.g., a web portal permitting participants to users add, modify, or delete content via a web browser), and approval of such changes may be based on the user's trust factor. Modifications by a user with a sufficiently high trust factor may be automatically approved for publication, but modifications by a user with a lower trust factor may require validation or seconding by an expert user (or other user with a sufficiently high user trust factor) before being approved. Problem or condition information and symptom information that may be subject to modification by users includes descriptions, potential treatments or mitigation strategies, prevention information, effects of potential treatments (e.g., drug side effects and/or drug interactions in the medical context), and related content.

In certain embodiments, users are permitted to contribute to a symptom list (or potential symptom list) demonstrative items representative of symptoms potentially related to the condition or problem. Examples of such demonstrative items include, but are not limited to (i) a photographic image, (ii) a video clip, (iii) a sound clip, and (iv) a diagnostic scanning image. In certain embodiments relating to the medical context, information identifying an individual or patient (e.g., a photograph or video showing a unique tattoo or the individual's entire face, or an image containing a patient's name) may be removed or obscured to avoid running afoul of laws or regulations (e.g., the U.S. Health Insurance Portability and Accountability Act) that prohibit publication of patient information. In certain embodiments, at the time a user initiates or seeks to initiate upload of a demonstrative item, pattern recognition relating to identifying information is automatically performed to discern unique identifying characteristics of a demonstrative item. If unique identifying characteristics are discerned, then in one embodiment publication of such demonstrative item would not be permitted (i.e., the demonstrative item would be filtered out). In another embodiment, following discernment of unique identifying characteristics, a modified demonstrative item with removed or obscured identifying characteristics is automatically generated and communicated to the user (or to a system administrator) for approval, and only after approval is granted is the modified demonstrative item made available for publication to others.

In certain embodiments, incentives may be provided to expert users and contributing users to encourage their participation in diagnosis systems and methods. Such incentives may include publicity, steering of search users to expert users for diagnostic or treatment/mitigation services or treatment/mitigation products, eligibility for discounted diagnosis or treatment services, or sharing with users of revenue (e.g., advertising revenue, subscription revenue, and/or revenues obtained from application developers seeking to interact with the diagnosis system) received by a system operator. In certain embodiments, an incentivized (expert or contributing) user may be identified via a communication interface with a hyperlink or other identifier(s) selected by the incentivized user to encourage usage of the hyperlink or other identifier(s) by search users. A hyperlink may be linked to a website of business or organization associated with the incentivized user, or linked to a website of a cause (e.g., charitable organization) of interest to the incentivized user. In certain embodiments, at the time one or more possible diagnoses for a condition or problem are communicated to a search user, the search user is provided with contact information for, or communication by the search user is automatically initiated with, any one or more of the following: (i) at least one expert user having expertise relating to the problem or condition, (ii) at least one provider of treatment or mitigation services relating to the problem or condition, and (iii) at least one provider of treatment or mitigation products relating to the problem or condition. In certain embodiments, one or more of the foregoing potential contact recipients (i), (ii), and (iii) may be identified to a search user based at least in part on geographic proximity (e.g., similar locality) of the potential contact recipient(s) to the search user. In certain embodiments, region or location of a user may be detected automatically based upon the IP address, telephone number, or other information indicative of locale associated with a signal received from the search user, or the search user may be prompted to enter region or locale.

In certain embodiments, a system as disclosed herein may include a communication interface for sending and receiving network messages and a control module coupled with the communication interface configured to collect and store electronic data from a search user seeking to obtain diagnosis of the condition or problem, apply stored diagnosis rules to the electronic data to identify at least one possible diagnosis of the condition or problem, and communicate to the search user at least one possible diagnosis of the condition or problem. The electronic data subject to receipt from a search user preferably includes information indicative of at least one symptom relating to the condition or problem and includes information indicative of geographic region or location of the search user. The stored diagnosis rules may include diagnosis rules generated from information contributed by any of (i) expert users and (ii) non-preselected contributing users (and preferably contributed by both expert users and non-preselected contributing users), and wherein each diagnosis rule has associated therewith a diagnosis rule trust factor.

In certain embodiments, he condition or problem includes at least one of the following: a medical condition, a disease, a drug interaction, and a drug side effect. In certain embodiments, the condition or problem includes a disease; and the control module is configured to identify trends of diagnosis results relating to the disease, and configured to report to at least one health authority information indicative of an increased temporal and/or geographic incidence of diagnosis results relating to the disease.

In certain embodiments, the control module may include a data collection engine configured to receive information from multiple computing devices via the communication interface.

In certain embodiments, the control module may include a learning engine configured to perform at least one of the following tasks: (i) infer diagnosis rules generated from information contributed by any of expert users and non-preselected contributing users; (ii) categorize diagnosis rules; (iii) adjust diagnosis rule trust factors associated with diagnosis rules; (iv) promote provisional diagnosis rules to confirmed diagnosis rules eligible for application to the electronic data to identify at least one possible diagnosis of the condition or problem; and (v) demote confirmed diagnosis rules to provisional diagnosis rules not eligible for application to the electronic data to identify at least one possible diagnosis of the condition or problem.

In certain embodiments, the control module includes a learning engine configured to: analyze stored information contributed by any of contributing users and expert users, and based on the analyzed information, perform any of the following: (i) generate new diagnosis rules, (ii) modify existing diagnosis rules, (iii) generate symptom descriptions, and (iv) modify existing symptom descriptions.

In certain embodiments, a control module is configured to elicit feedback from a search user via the communication interface, wherein the feedback is indicative of accuracy or perceived accuracy of the at least one possible diagnosis. Moreover, the control module may be configured to adjust at least one diagnosis rule trust factor based on search user feedback regarding accuracy or perceived accuracy of diagnoses generated by applying stored diagnosis rules, and configured to store the adjusted at least one diagnosis rule trust factor.

In certain embodiments, the control module may be configured to access a first database including provisional diagnosis rules that are not eligible for application to the electronic data to identify at least one possible diagnosis of the condition or problem, and the control module may be configured to access a second database including confirmed diagnosis rules that are eligible for application to the electronic data to identify at least one possible diagnosis of the condition or problem.

In certain embodiments, a control module may be configured to receive, from a non-preselected contributing user, electronic data including information indicative of at least one symptom of a condition or problem, and indicative of a diagnosis of the condition or problem corresponding to the at least one symptom; generate a new diagnosis rule based on the information received from the non-preselected contributing user; associate a diagnosis rule trust factor with the new diagnosis rule; and apply the new diagnosis rule in conjunction with the stored diagnosis rules to the electronic data collected from the search user to identify a plurality of possible diagnoses of the condition or problem.

In certain embodiments, a method for diagnosing a condition or problem includes use of least one computing device to perform steps including: collecting and storing electronic data from a search user seeking to obtain diagnosis of the condition or problem, wherein the electronic data includes information indicative of at least one symptom relating to the condition or problem and includes information indicative of geographic region or location of the search user; applying stored diagnosis rules to the electronic data to identify at least one possible diagnosis of the condition or problem, wherein the stored diagnosis rules includes diagnosis rules generated from information contributed by any of (i) expert users and (ii) non-preselected contributing users (preferably including information contributed by both expert users and non-preselected contributing users) and wherein each diagnosis rule has associated therewith a diagnosis rule trust factor; and communicating to the search user the identified at least one possible diagnosis of the condition or problem.

In certain embodiments, a plurality of possible diagnoses of the condition or problem are provided, wherein the communicating to the search user of possible diagnoses includes ranking possible diagnoses of the plurality of possible diagnoses based at least in part on diagnosis rule trust factors associated with the diagnosis rules used to identify the respective possible diagnoses. In certain embodiments, the ranking of possible diagnoses is based in part on said information indicative of geographic region or location of the search user.

In certain embodiments, a diagnosis method includes eliciting feedback from the search user indicative of accuracy or perceived accuracy of the at least one possible diagnosis. In certain embodiments, at least one diagnosis rule trust factor is adjusted based on search user feedback regarding accuracy or perceived accuracy of diagnoses generated by applying the stored diagnosis rules, and storing the adjusted at least one diagnosis rule trust factor (e.g., in at least one memory element).

In certain embodiments, at least one diagnosis rule trust factor is adjusted based on input received from at least one expert user. Such adjustment may be further based at least in part on input received from other user types.

In certain embodiments, collecting electronic data from a search user to facilitate diagnosis of a condition or problem includes presenting the search user with at least one demonstrative item representative of a symptom potentially related to the condition or problem, the demonstrative item comprising any of (i) a photographic image, (ii) a sound clip, (iii) a video clip, and (iv) a diagnostic scanning image; and eliciting information from the search user indicative of at least one symptom of the condition or problem based on the search user's review of the at least one demonstrative item.

In certain embodiments, at least one of the following is communicated to a search user: (i) at least one option for treating or mitigating the problem or condition, and (ii) potential conflicts between strategies for treating or mitigating the problem or condition.

In certain embodiments, based on at least one possible diagnosis of the condition or problem identified to the search user, a search user is provided with contact information for, or communication by the search user is initiated with, any one or more of the following: (i) at least one expert user having expertise relating to the problem or condition, (ii) at least one provider of treatment or mitigation services relating to the problem or condition, and (iii) at least one provider of treatment or mitigation products relating to the problem or condition. In certain embodiments, at least one expert user having expertise relating to the problem or condition, at least one provider of treatment or mitigation services relating to the problem or condition, and/or at least one provider of treatment or mitigation products relating to the problem or condition, is identified to the search user based at least in part on geographic proximity to the search user.

In certain embodiments, a method includes receiving, from a non-preselected contributing user, electronic data including information indicative of at least one symptom of a condition or problem, and indicative of a diagnosis of the condition or problem corresponding to the at least one symptom; generating a new diagnosis rule based on the information received from the non-preselected contributing user; associating a diagnosis rule trust factor with the new diagnosis rule; and applying the new diagnosis rule in conjunction with the stored diagnosis rules to the electronic data collected from the search user to identify a plurality of possible diagnoses of the condition or problem. In certain embodiments, the diagnosis rule trust factor associated with the new diagnosis rule is based at least in part on a contributing user trust factor associated with the contributing user.

In certain embodiments, a method for diagnosing a condition or problem includes utilizing at least one computing device (e.g., including at least one processor and at least one memory element) to perform steps including: collecting and storing electronic data from a search user seeking to obtain diagnosis of the condition or problem, wherein the electronic data includes information indicative of at least one symptom relating to the condition or problem and includes information indicative of geographic region or location of the search user; applying stored diagnosis rules to the electronic data to identify a plurality of possible diagnoses of the condition or problem, wherein each diagnosis rule has associated therewith a diagnosis rule trust factor; and communicating to the search user the plurality of possible diagnoses of the condition or problem, wherein such identifying includes ranking the possible diagnoses based at least in part on diagnosis rule trust factors associated with the diagnosis rules used to identify the respective possible diagnoses. In certain embodiments, the ranking of the possible diagnoses is based in part on said information indicative of geographic region or location of the search user. In certain embodiments, a method may further include adjusting at least one diagnosis rule trust factor based on search user feedback regarding accuracy or perceived accuracy of diagnoses generated by applying the stored diagnosis rules, and storing the adjusted at least one diagnosis rule trust factor in the at least one memory element.

In certain embodiments, a method for promoting diagnosis of a condition or problem includes utilizing at least one computing device to perform steps including: receiving user information from an expert user candidate and electronically storing the user information in the at least one memory element; verifying user information received from the expert user candidate in order to validate the expert user candidate as an expert user; assigning an expert user trust factor to the expert user; and updating the expert user trust factor based upon at least one of the following: (i) receipt of ratings of the expert user generated by search users seeking diagnosis of conditions or problems; and (ii) confirmation of validity of diagnosis rules generated from information contributed by the expert user, wherein said diagnosis rules are useable to automatically diagnose a condition or problem based upon information received from a search user including information indicative of at least one symptom relating to the condition or problem and including information indicative of geographic region or location of the search user.

In certain embodiments, a method for promoting diagnosis of a condition or problem includes utilizing at least one computing device to perform steps including: collecting and storing electronic data from a search user seeking to obtain diagnosis of the condition or problem, wherein the electronic data includes at least one identified symptom relating the condition or problem and at least one identifier indicative of geographic region or location of the search user, wherein the collecting comprises use of a graphical user interface associated with a computing device, and wherein the storing comprises storage of collected electronic data transmitted via an electronic communication network; applying diagnosis rules to the electronic data to identify at least one possible diagnosis of the condition or problem, wherein the diagnosis rules include associated rule trust factors; eliciting feedback from the search user seeking to obtain diagnosis of the condition or problem, wherein said feedback is indicative of accuracy of the at least one possible diagnosis; and adjusting at least one rule trust factor based on feedback from the user, and storing the adjusted at least one rule trust factor in the at least one memory element.

In certain embodiments, if a search user does not receive a satisfactory diagnosis to a condition or problem after reviewing potential diagnosis and after considering suggested symptoms, the search user may be contacted (e.g., via email) after the user visits a diagnosis and/or treatment professional to elicit identification of the diagnosis so that the system may be updated to include the diagnosis as associated with symptoms experienced or otherwise identified by the search user, for use by the learning engine.

In certain embodiments, if a search user does not receive a satisfactory diagnosis to a condition or problem after reviewing potential diagnosis and after considering suggested symptoms, the system may be configured to permit the user to request bids from expert users for diagnosis. A search user may choose the winner based on entry by an expert user of a satisfactory bid, and the search user may tender payment to the expert user who then provides a diagnosis (optionally in conjunction with scheduling a diagnostic visit or consultation between the search user and expert user).

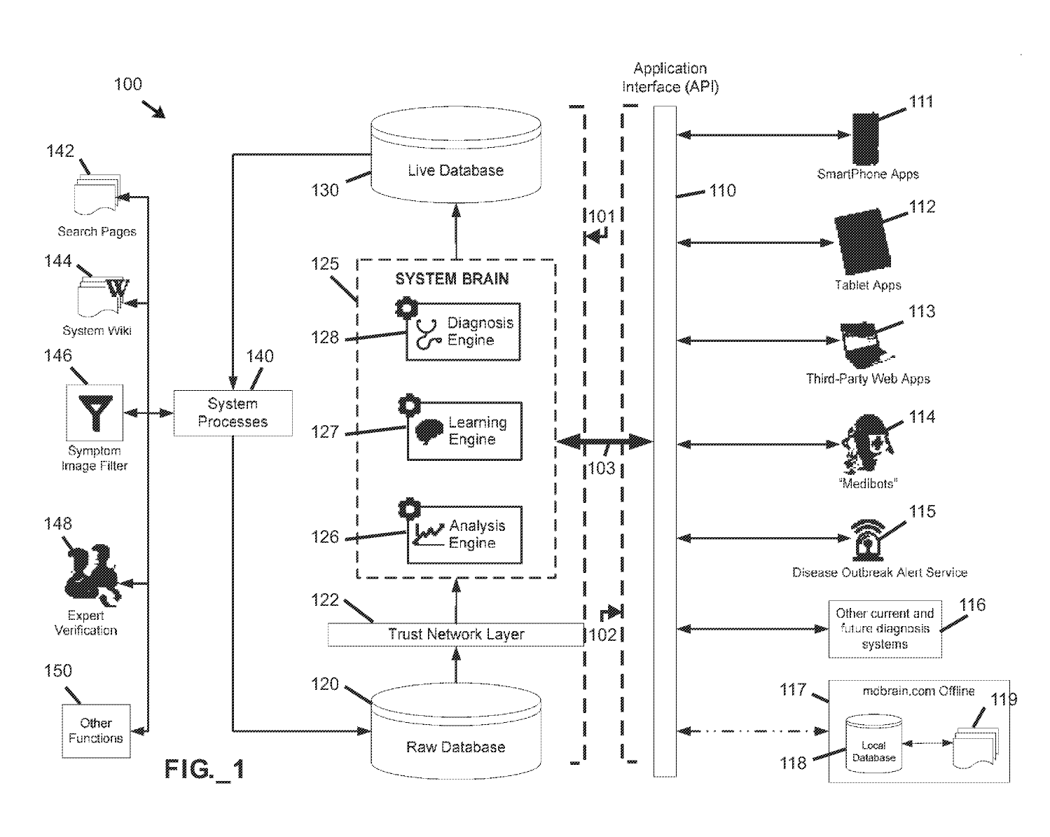

FIG. 1 illustrates connections between various elements of an exemplary system 100 for diagnosing a condition or problem according to one embodiment, the system 100 the including use of a control module 101 and a communication interface 102 including use of an electronic communication network 103. The control module 101 includes a system brain 125 arranged to communicate with a raw database 120 and a live database 130, with the system brain 125 including an analysis engine 126, a learning engine 127, and a diagnosis engine 128. A trust network layer 122 is preferably arranged between the raw database 120 and the system brain 125. Various system processes 140 may access the raw database 120 and/or live database 130, such as search pages 142, a system Wiki 144, a symptom image filter 146, expert verification 148, and other functions 150 such as may entail access by administrators or users. An application program interface (API) 110 is arranged to facilitate communication between various applications (e.g., applications arranged to operate on computing devices) and the system brain 125 via the network 103. Applications (a/k/a “apps”) arranged to communicate with the system brain 125 via the network 103 and the API 110 include, but are not limited to, smartphone apps 111, tablet (computer) apps 112, third party Web apps 113, medical robots (a/k/a “medibots”) 114, disease outbreak alert service apps 115, other current and future diagnosis system apps 116, and (at least periodically) offline apps 117 such as may include a local database 118 and local network devices 119, with the local database 118 being arranged to communicate via the API 110 with the learning engine 103 at least periodically for updating of the local database 118. In one embodiment, the local database 118 may be implemented in smartphone or other computing device, optionally in the form of a removable media (e.g., a flash memory card such as microSD or similar format). A local database 118 may represent a “light” version of a more fully featured database to tailor the local database to problems or conditions of particular relevance to a specific area, and to render to local database compatible with memory limitations of a specified computing device.

Within the system brain 125, a primary function of the analysis engine 126 is to analyze data received from the raw database 120 and/or the network 103. In the context of medical diagnosis, analysis performed by the analysis engine 126 may include identification of trends of diagnosis results (possibly in combination with search results), and when trends indicate increased temporal and/or geographic incidence of diagnosis results relating, the analysis engine 126 may communicate with a disease outbreak alert service 115 or other health authority to report such results as possibly indicating outbreak of a disease. The analysis engine 126 may also provide data mining functions (e.g., mining the raw database) to supply information to the learning engine 127. A primary function of the diagnosis engine 128 is to apply diagnosis rules to information (e.g., information indicative of symptoms, preferably in combination with geographic or region information) received from users via the network 103. Primary functions of the learning engine 127 include inferring new diagnosis rules from previously entered information and diagnosis results, and inferring potential modifications to existing diagnosis rules (which may be subject to validation by expert users and/or system administrators). The learning engine may use one or more of machine learning techniques, statistical techniques, logical algorithm techniques, third party system inputs, and/or human inputs. Functions that may be performed by or more of the three engines 126-128 include filtering and categorization of diagnosis rules, and data mining.

The system brain 125 may include software executed by one or more processors. In one embodiment, the system brain 125 may be implemented in a distributed manner in computing devices that are geographically distributed and arranged to operate in parallel to facilitate rapid local access and promote uninterrupted operation of the system 100 in case one such computing device should fail or require maintenance. Likewise, the raw database 120 and live database 130 may be implemented in one or more non-transitory computer readable data storage elements, and more preferably implemented in a distributed manner in multiple data storage elements that are geography distributed, arranged to operate in parallel, and arranged for periodic synchronization of data among multiple raw database storage elements and among multiple live database storage elements. The raw database 120 preferably stores provisional diagnosis rules (e.g., diagnosis rules that have been proposed by users or inferred (e.g., by either the analysis engine 126 or the learning engine 127), but not yet confirmed (e.g., promoted to the live database 130) for use in being applied to electronic data entered by search users to diagnose a condition or problem. The raw database 120 may also store information (e.g., search information) entered by users to provide a basis inferring and/or validating diagnosis rules. One or both of the raw database 120 and the live database 130 may store information used by various system processes (e.g., search pages 142, system Wiki 144, demonstrative item (e.g., symptom image) filter 146, expert verification tool(s) 148, and other functions 150).

The trust network layer 122 may be used as an intermediary between the raw database 120 and the system brain 125, and may be responsible for applying trust factors, maintaining trust factors, and/or associating trust factors relating to information contained in the raw database 120. Various system processes 140 may also be intermediately arranged between the live database 130 and the raw database 120 to communicate information in one or more directions.

Among various specific system processes that may be employed, search pages 142 include layout, menus, and/or content that may be used in graphical interfaces for performing searches seeking to identify diagnoses for conditions or problems. The system Wiki may include layout, menus, and/or content relating to problem or condition information, symptom information, and associated information (e.g., treatment/mitigation information, prevention information, treatment side effect information, treatment incompatibility information, and/or links to resources) that may be editable by users (preferably expert users and contributing users) by addition, modification, or deletion via a web browser or other graphical interface.

A demonstrative item filter 146 may be used to filter inappropriate or prohibited demonstrative items uploaded by users (with such items including, but not limited to, (i) photographic images, (ii) a video clips, (iii) sound clips, and (iv) diagnostic scanning images). For example, demonstrative items including identifying characteristics of specific individuals may be automatically discerned (e.g., by pattern recognition) and filtered, with relevant steps taken upon such identification prevent inappropriate or prohibited demonstrative items from becoming publicly available.

An expert verification tool 148 may be used to verify identity of expert candidates before such candidates are approved as expert users. The expert verification tool 148 may perform an automated or semi-automated review of identifying information and qualifications associated with the expert, such as by contacting professional licensing boards, government authorities, trade groups, other experts, or other relevant institutions, to verify whether the expert candidate is sufficient qualified and/or is recognized by others to have sufficient qualifications to assist in diagnosing problems or conditions in a specified technical or professional field.

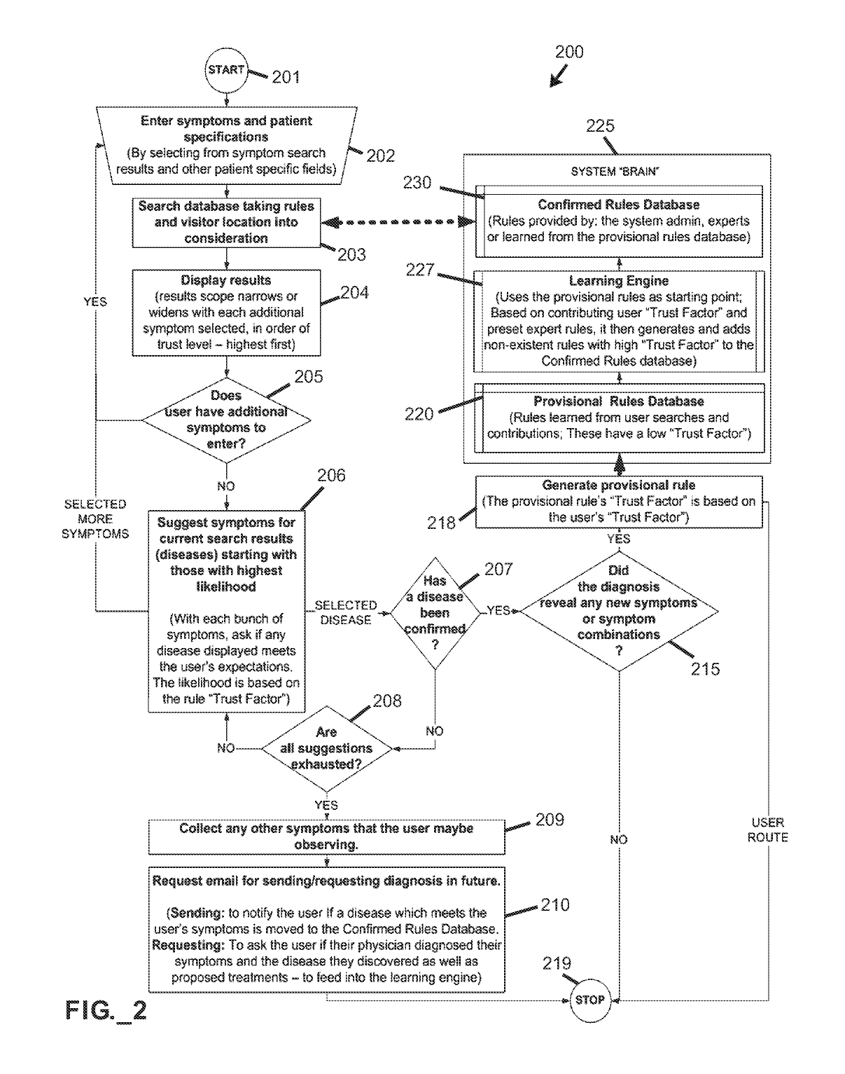

FIG. 2 is a flowchart identifying various steps of a method 200 for diagnosing a condition or problem including a system as disclosed herein. Method steps progress from a start block 201. After an optional initial step (not shown) of a search user creating an account and entering identifying information (e.g., username, password, and email address or other contact information), a search user may enter symptoms and patient specifications (e.g., by selecting from results of symptom searches and other patient-specific fields) according to block 202. A live database may be searched taking rules and search user location into consideration according to block according to block 203.

The search according to block 203 is preferably performed by a system brain 225, with the brain 225 arranged to access a live database 230 that includes confirmed diagnosis rules and the brain being arranged to access a raw database 220 that includes provisional diagnosis rules that have not yet been confirmed. Confirmed diagnosis rules have a high trust factor above a desired threshold, and may include diagnosis rules provided by expert users or system administrators, rules provided by contributing users and confirmed by expert users or system administrators, rules learned from user searches / contributions and (preferably) validated by expert users, or rules learned from data mining/analysis and (preferably) validated by expert users. The system brain 225 includes a learning engine 227 that preferably uses provisional diagnosis rules as a starting point, and may promote provisional diagnosis rules to the live database 230 based on user trust factor of the contributing user and/or based on validation by an expert user.

Referring back to block 203, after the live database is searched, results of the database search are displayed or otherwise communicated to the search user according to block 204. The scope of potential diagnosis results is altered (e.g., narrowed or widened) with each additional symptom selected. Where multiple possible diagnoses are presented, the possible diagnoses are preferably ranked based at least in part on diagnosis rule trust factors associated with the diagnosis rules used to identify the respective possible diagnoses, including identification of the possible diagnosis or diagnoses considered most likely to correspond to the entered symptoms.

After possible diagnoses are displayed or otherwise communicated to the search user, the search user may be queried as to whether the search user has any additional symptoms to enter according to block 205. If the search user responds affirmatively to such query, then the method returns to block 202 to permit the user to enter additional symptoms and a further database search is performed at block 203. Alternatively, if the search user responds negatively to the search query in block 205, then additional suggested symptoms corresponding to current potential diagnosis results (e.g., starting with those having the highest likelihood, with consideration of respective diagnosis rule trust factors and possibly also considering the user's locale) may be displayed or otherwise communicated to the search user according to block 206. With each bunch of symptoms, the search user is preferably queried whether any identified potential diagnosis (search result) meets the search user's expectations according to block 207.

If the search user responds negatively to the inquiry in block 207 regarding correctness of the potential diagnosis, then further action may depends on whether all suggested symptoms have been exhausted according to block 208. If additional suggested symptoms exist in the system, then the method proceeds to block 206 to suggest to the search user additional symptoms corresponding to the potential diagnosis results. Conversely, if no additional suggested symptoms exist in the system, then the search user may be prompted to enter additional symptoms that the search user may be observing according to block 209, and then, according to block 210, the search user may be requested to enter an email address or other contact information (if an email address or contact information for the search user was not previously obtained) for sending the user the diagnosis in the future (e.g., if a diagnosis meeting the search user's symptoms is moved to the live database) or for requesting the user to communicate the diagnosis in the future (e.g., if the search user obtains a diagnosis from a diagnosis professional).

Referring back to block 207, if the user responds affirmatively that the identified potential diagnosis is correct, then the method proceeds to block 215 to consider whether the diagnosis revealed any new symptoms or symptom combinations. If so, then a provisional diagnosis rule (with a low trust factor) may be created using the symptoms and diagnosis according to block 218. Generation of a provisional diagnosis rule (i.e., with a low trust factor of a magnitude insufficient for inclusion in the live database 230) according to block 218 can also be can also be performed by a contributing user.

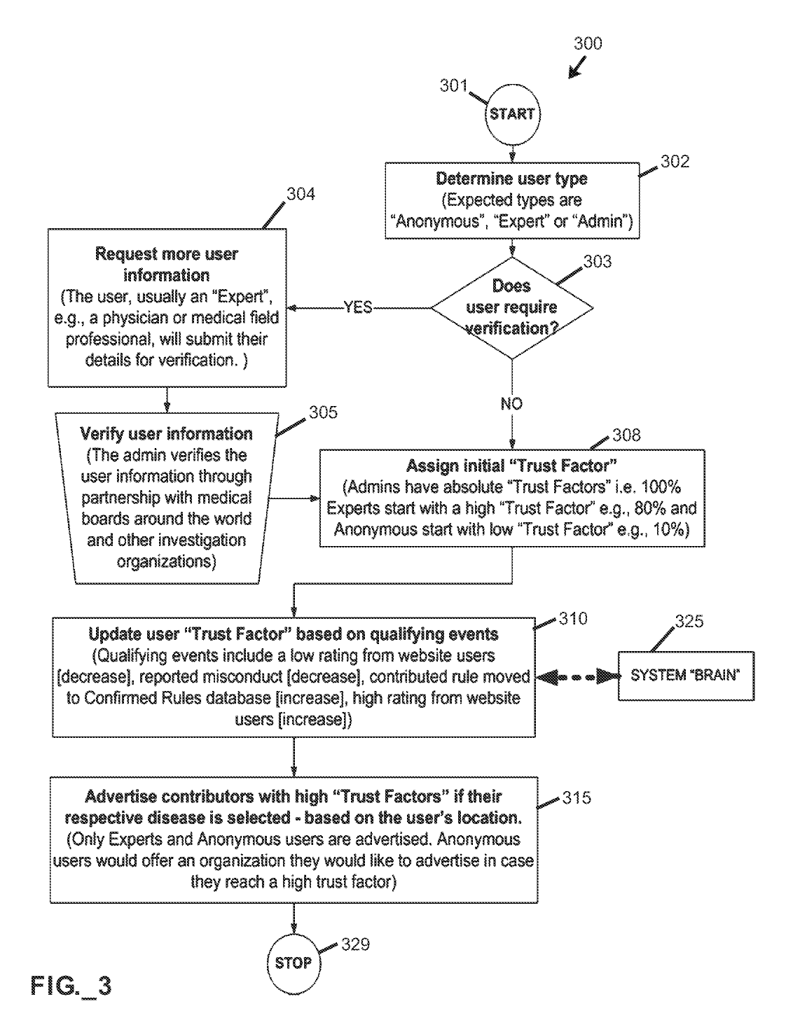

FIG. 3 is a flowchart identifying various steps of a method for establishing and/or altering user trust factors using a system as disclosed herein. Method steps progress from a start block 301. After an optional initial step (not shown) of a user creating an account and entering identifying information (e.g., username, password, and email address or other contact information), a user search type is determined according to block 302, with expected user types including expert, administrator, or anonymous (as may be applied to a contributing user without expert qualifications). The need for user verification (e.g. as appropriate to expert users) is assessed according to block 303. If verification is required, then the user is requested to provide more user information (e.g., with the expert user candidate being requested to furnish details regarding qualifications to enable verification of the expert user candidate) according to block 304. Information for expert user candidates may be verified according to block 305, whether checked by human intervention (e.g., by system administrators) and/or automatically via network communication and hardware/software implementation, to compare qualifications and experience of the expert to records obtainable from professional licensing boards, government authorities, trade groups, other experts, investigatory organizations, or other relevant institutions in order to verify whether the expert candidate should be approved as an expert user. If information provided by an expert user candidate is verified as an expert user according to block 305, or if no verification of a user is required according to block 303, then the method progresses to assignment of a user trust factor according to block 308, wherein a system administrator preferably is assigned an absolute trust factor (e.g., 100%), an expert user may be assigned a high but not absolute initial user trust factor (e.g., a starting value of 80%), and an anonymous (e.g., contributing) user may be assigned a low initial user trust factor (e.g., a starting value of 10%). After a user trust factor is assigned according to block 308, a user's trust factor may be updated (e.g., by interaction with the system brain 325) based on qualifying events according to block 310. Qualifying events may include, but are not limited to, receipt of ratings from other system users (which may be applied to increase or decrease user trust factor), receipt of reports of misconduct by other system users (which may be applied to decrease user trust factor), and confirmation (e.g., movement to the live database) of diagnosis rules contributed by an expert user or contributing user (which may increase the user trust factor of the expert user or contributing user).

Continuing to refer to FIG. 3, according to block 315, expert users and contributing users with high trust factors may be advertised to a search user if a diagnosis contributed by such expert user or contributing user, or a diagnosis validated by an expert user (or contributing user), is selected by the search user. In certain embodiments, advertisement of one or more expert users may be contingent, or advertisement of multiple expert users may be ranked, based at least in part on geographic proximity of expert users to a search user selecting the diagnosis. In certain embodiments, advertisement and/or ranking of one or more expert users in response to selection of a diagnosis by a search user may be based at least in part on advertising fees paid by expert users or related organizations. In certain embodiments, at the time one or more possible diagnoses for a condition or problem are communicated to a search user, the search user is provided with contact information for, or communication by the search user is automatically initiated with, any one or more of the following: (i) at least one expert user having expertise relating to the problem or condition, (ii) at least one provider of treatment or mitigation services relating to the problem or condition, and (iii) at least one provider of treatment or mitigation products relating to the problem or condition. In certain embodiments, one or more of the foregoing potential contact recipients (i), (ii), and (iii) may be identified to a search user based at least in part on geographic proximity (e.g., similar locality) of the potential contact recipient(s) to the search user. Advertisement by a contributing user may include links to organizations or causes (e.g., charitable organizations) selected by the contributing user, with such advertisement preferably being contingent on a contributing user attaining and/or maintaining a sufficiently high user trust factor. The foregoing advertisements incentivize expert users and contributing users to provide accurate contributions to the diagnosis system to improve its functionality. Steps of a method according to FIG. 3 end at block 329.

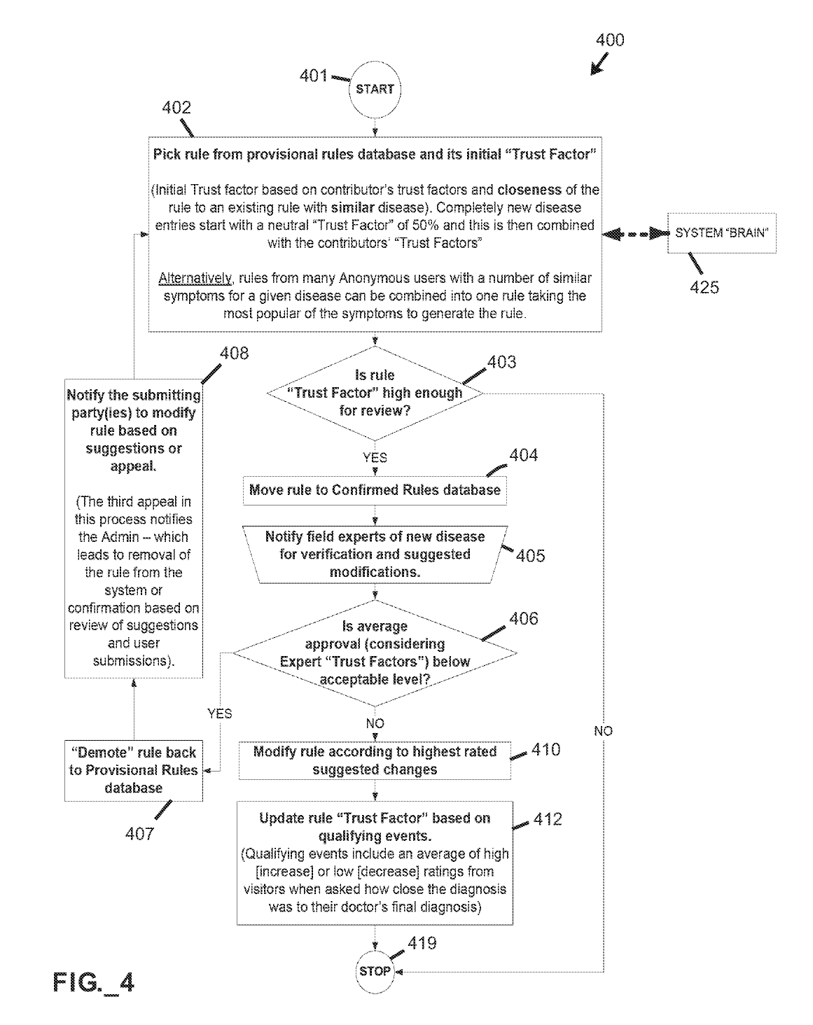

FIG. 4 is a flowchart identifying various steps of a method 400 for reviewing and evaluating provisional diagnosis rules for possible validation and inclusion in a live database that may be used in a system as disclosed herein. Method steps progress from a start block 401. A provisional diagnosis rule and its current (e.g., initial) rule trust factor are selected at block 402. An initial trust factor of a provisional diagnosis rule may be based on at least one of (i) a user trust factor of a user contributing the provisional diagnosis rule, and (ii) closeness of the provisional diagnosis rule to an existing (e.g., confirmed) diagnosis rule for a similar disease. A completely new provisional diagnosis rule entry may start with a neutral rule trust factor (e.g., a value of 50%) and this rule trust factor may be modified or combined with the trust factor of the user who contributed the rule. In one embodiment, rules from many contributing users with a number of similar symptoms for a given disease may be combined into one provisional diagnosis rule, taking into account the most popular (e.g., most frequently identified) symptoms used to generate the provisional diagnosis rule. The diagnosis rule trust factor of a provisional diagnosis rule is compared to a predetermined threshold to determine whether the diagnosis rule trust factor is sufficiently high to consider the provisional diagnosis rule for review for possible confirmation according to block 402. If so, then the provisional diagnosis rule may be moved to a confirmed or live database of confirmed diagnosis rules (or alternatively to an intermediate database) according to block 404. Expert users may be notified of the need to review the diagnosis rule for verification and possible modifications according to block 405. Next, average approval (considering expert user trust factors) of the new diagnosis rule relative to a predetermined threshold is considered at block 406. If the average approval is not below an acceptable level, then the diagnosis rule is confirmed, optionally with modification according to the highest rated suggested changes received from expert users, according to block 410. Thereafter, a rule trust factor associated with the confirmed diagnosis rule may be updated according to qualifying events (e.g., receipt of ratings from search users when queried as to the closeness of the diagnosis rule to the search user's expectation and/or closeness of the diagnosis rule to a final diagnosis received from the search user's diagnosis professional). Referring back to block 406, if the average approval of the new diagnosis rule relative to a predetermined threshold is below an acceptable level, then the diagnosis rule may be demoted back to a provisional rule database (e.g., raw database) according to block 407. Thereafter, any party or parties responsible for submitting the diagnosis rule may be notified to modify the rule based on suggestions or an appeal decision according to block 408. A system administrator may be notified after one or more review or appeal steps to consider a demoted provisional rule for removal from the system, or to consider modification and maintenance a provisional rule (preferably to be seconded by at least one expert user) based on suggestions and/or user submissions). Any maintained and/or modified provisional rule may be subsequently considered for review according to block 402.

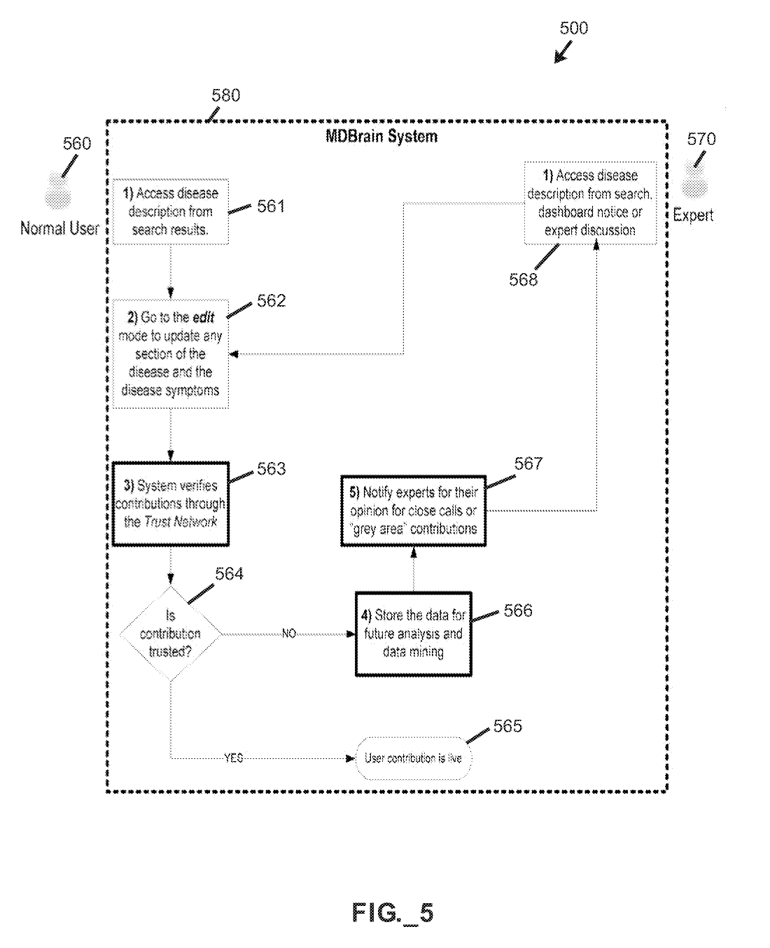

FIG. 5 is a flowchart identifying various steps of a method 500 for modifying disease descriptions and/or symptoms that may be used in a system 580 as disclosed herein. Modifications may be initiated by a non-expert (e.g., contributing) user 560 according to block 561 (e.g., by accessing a disease description from search results), or may be initiated by an expert user 570 according to block 568 (e.g., by accessing a disease description from search results, from dashboard notification (e.g., notification from a system administrator), or from expert discussion). According to block 562, a user may select an “edit” mode to update (whether by addition, deletion, or modification) any section and symptoms thereof (e.g., including descriptions and/or demonstrative items). The resulting updated information is considered a contribution, and may be stored in a raw database. The contribution is then subject to verification by expert users and/or contributing users via a trust network (e.g., according to trust network layer 122 depicted in FIG. 1). The user trust level of the contributing user may be considered separately or in conjunction with the trust level of one or more expert users and/or contributing users that review the contribution, with the trust level of the contribution (e.g., embodying a modified diagnosis rule) relative to a predetermined threshold trust level being considered at block 564. If the contributed diagnosis rule has a sufficiently high diagnosis rule trust factor, then the diagnosis rule is confirmed and moved to the live database according to block 565. Conversely, if the contributed diagnosis rule does not have a sufficiently high diagnosis rule trust factor, then the diagnosis rule is stored (e.g., in the raw database, such as among other provisional rules) for future analysis and data mining according to block 566. For any such stored diagnosis rule, experts may be contacted to elicit their opinions relating to any close calls or “gray area” contributions according to block 567, with the resulting diagnosis rule subject to access and possible modification by experts again according to block 568.

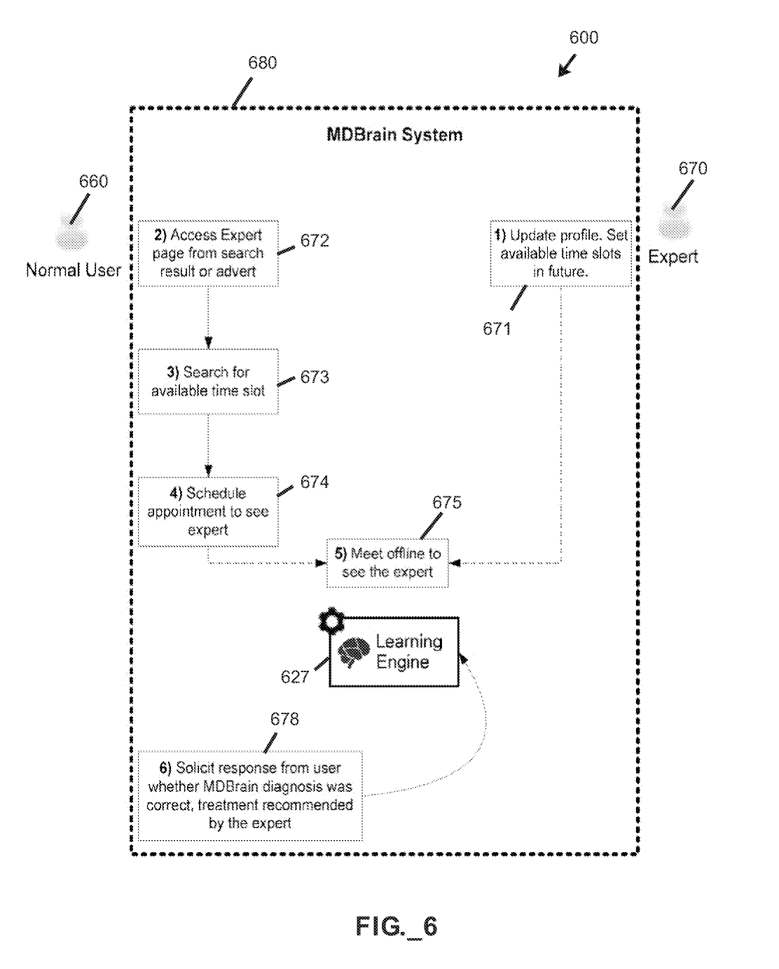

FIG. 6 is a flowchart identifying various steps of a method 600 for coordinating in-person interaction between a user seeking diagnosis of a problem or condition and an expert to promote diagnosis of the problem or condition, and for eliciting feedback from the user seeking diagnosis, according to a system 680 as disclosed herein. An expert user 670 may update the expert user's profile and identify available (future) time slots for meeting with search users according to block 671. A search user 660 may access an expert user interface page (e.g., Web page associated with the expert user) from an online diagnosis search result or associated advertisement accessible in conjunction with a search result according to block 672. A search user may search for at least one available time slot for meeting with the expert user according to block 673 and then schedule an appointment to see the expert user according to block 674. The search user 660 and expert user 670 may meet offline (e.g., in person) according to block 675. After this meeting, the search user 660 may be contacted by the system 680 (e.g., via email or other network communication method) to elicit feedback from the search user regarding one or more of the following issues: whether a diagnosis received from the search user's search of the system 680 was correct; identification of a diagnosis obtained from the expert user; and treatment recommended by the expert user, according to block 678. Feedback received from the search user according to block 678 is stored (e.g., in a raw database) and accessible by a learning engine 627 to assist in validating and/or modifying diagnosis rules or associated trust factors and for associated data mining, in order to permit accuracy of diagnosis rules to be improved.

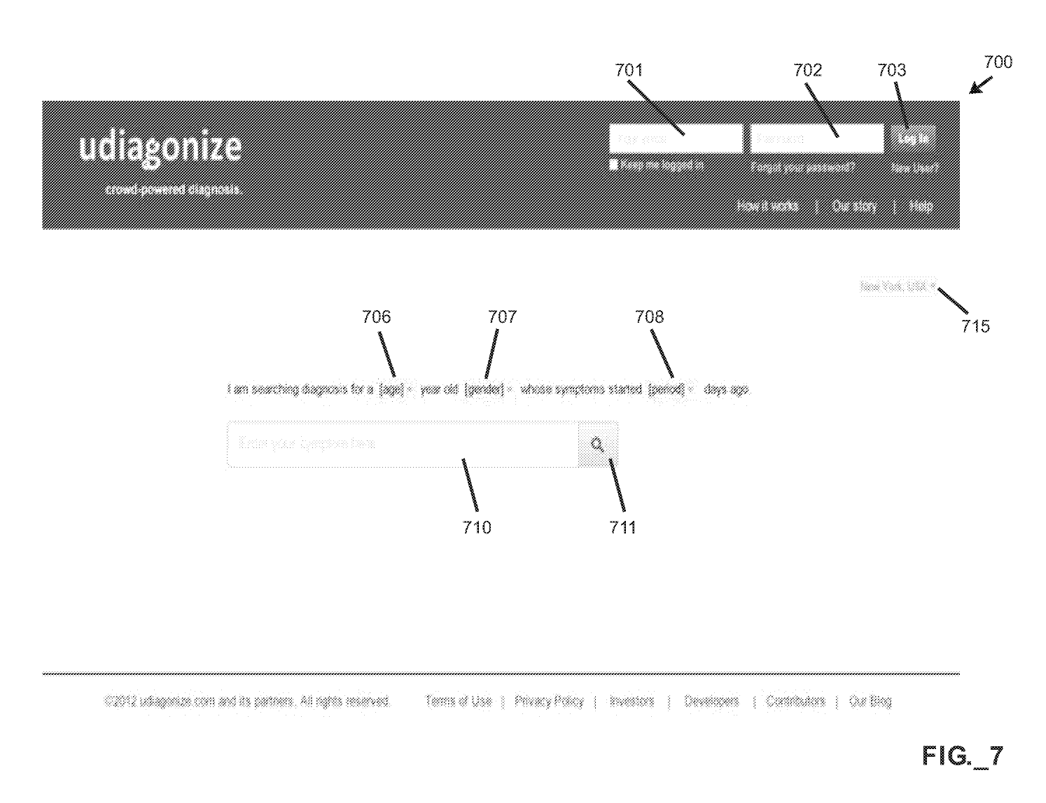

FIG. 7 is an image of a first user interface screen 700 for accessing a Web-based system for diagnosis of medical conditions or problems, the first user interface screen 700 including a symptom entry dialog box 710 and search button 711 permitting a user to search and/or enter symptoms. The screen 700 includes a user name dialog box 701 permitting entry of a user name (e.g., an email address), a password dialog box 702 permitting entry of a password, a “log in” button 703. The screen 700 further includes dialog boxes 706-708 embedded in a sentence stating “I am searching for a diagnosis for a ‘age’ (dialog box 706 prompting the user to enter age) year old ‘gender’ (dialog box 707 prompting the user to enter gender) whose symptoms started ‘period’ (dialog box 708 promoting the user to enter period in days since the symptoms started) days ago.” The screen 700 further includes a region or locale dialog box 715 depicting (in this case) “New York, USA.” The region or locale may be detected automatically based upon the IP address, telephone number, or other information indicative of locale associated with a signal received from the search user, or the search user may be prompted to enter region or locale.

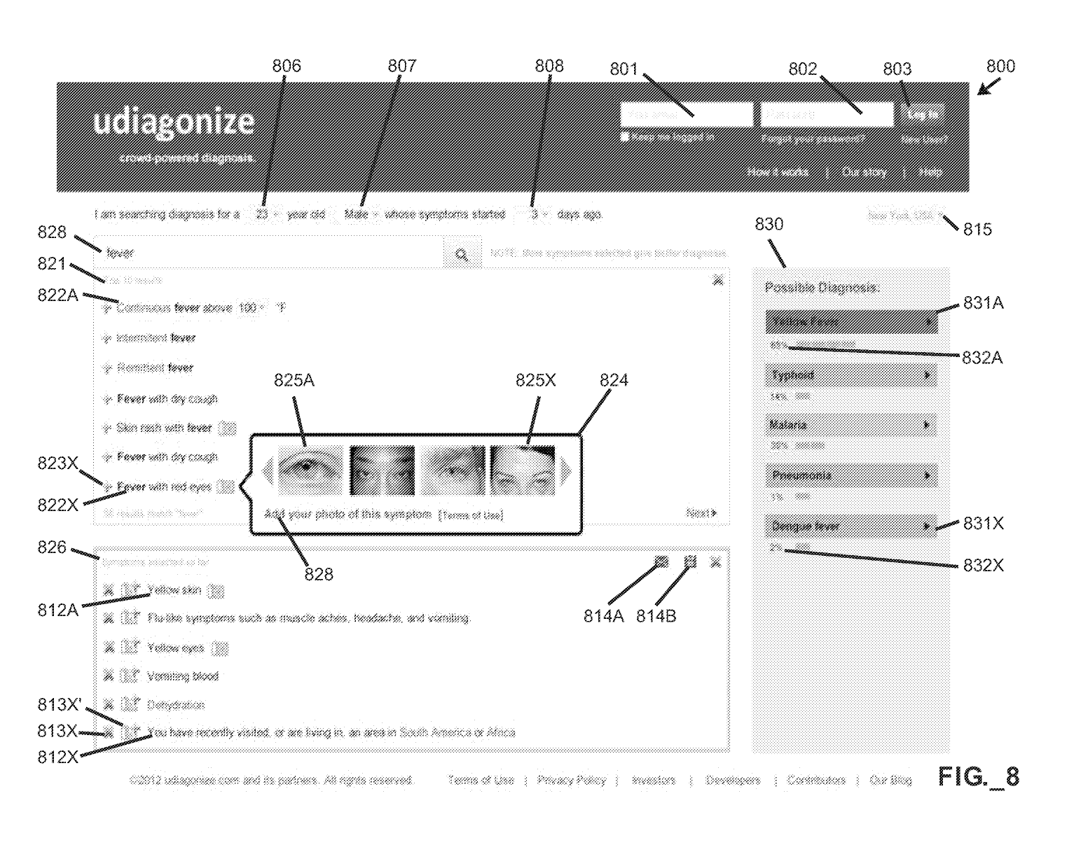

FIG. 8 is an image of a second user interface screen 800 for accessing a Web-based system for diagnosis of medical conditions or problems, the second user interface screen 800 including a listing 826 of symptoms entered by a search user and searched so far, a listing 821 of suggested symptoms, and an identification 830 of multiple possible diagnoses 831A-831X ranked according to probability of each respective diagnosis corresponding to the searched symptoms 826. Each possible diagnosis 831A-831X is presented with an associated correctness probability 832A-832A. The listing 826 of symptoms entered by a search user and searched so far includes symptom entries 812A-812X each including an associated expand button 813X′ to provide additional details, and each including a remove button 813X to remove the symptom from the listing 826. (Although six symptom entries 821A-821X are shown, only the first and last entries are labeled with element numbers, and it is to be understood that any desirable number of symptoms may be identified, such that the suffix “X” associated with the final symptom entry 821X represents a variable without limitation). The listing 826 of symptoms entered thus far further includes an email button 814A (e.g., permitting a user to email a listing of symptoms to another party) and a save button 814B (e.g., permitting a user to save a list of symptoms entered thus far) according to an account accessible (e.g., online via the World Wide Web) via a username and password. Within the listing 821 of suggested symptoms 822A-822X, each symptom includes an expand button 823X, and various symptoms such as the last symptom entry 822X may have associated demonstrative items 825A-825X that may be presented in a demonstrative item window 824 that may be viewable based on a user's selection, and with the demonstrative item window 824 including an add button 828 permitting a user to add one or more demonstrative items representative of symptoms potentially related to the condition or problem. The second user interface screen 800 further includes a symptom entry dialog box 828 permitting a user to search for additional symptoms, a user name dialog box 801 permitting entry of a user name (e.g., an email address), a password dialog box 802 permitting entry of a password, a “log in” button 803, and dialog boxes 806-808 embedded in a sentence stating “I am searching for a diagnosis for a ‘age’ (dialog box 806 prompting the user to enter age) year old ‘gender’ (dialog box 807 prompting the user to enter gender) whose symptoms started ‘period’ (dialog box 808 promoting the user to enter period in days since the symptoms started) days ago.” The screen 800 further includes a region or locale dialog box 815 depicting (in this case) “New York, USA.”

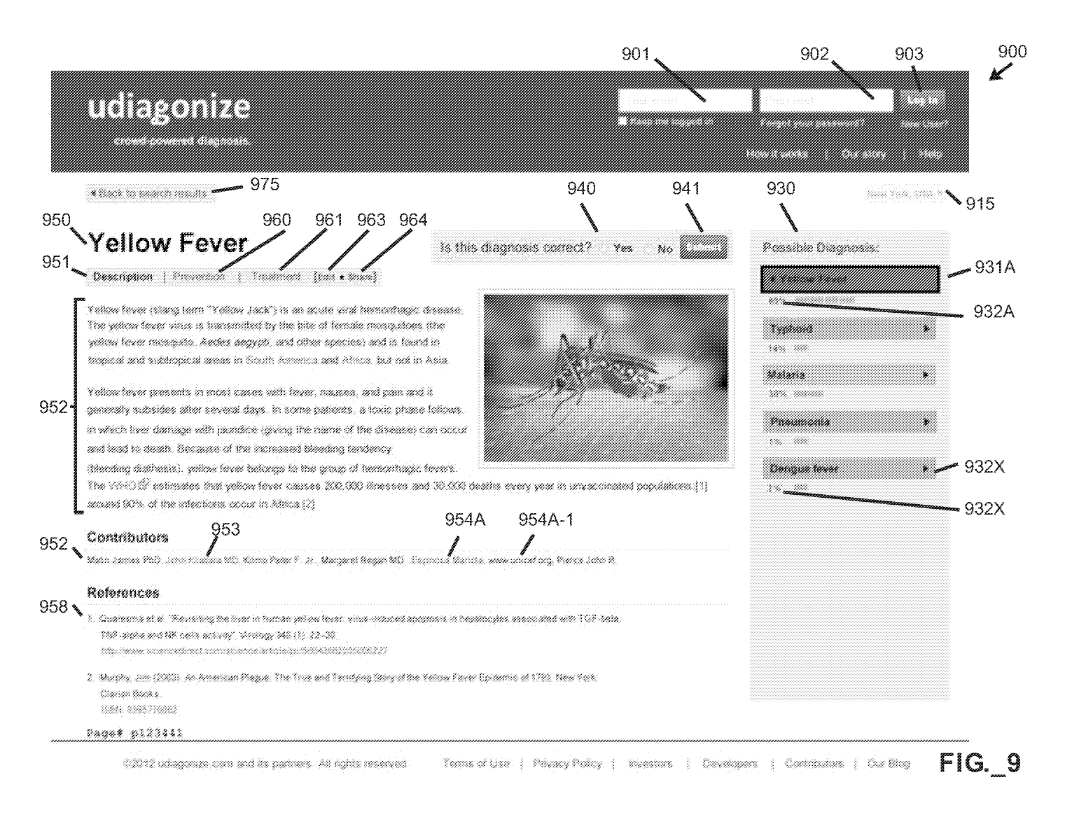

FIG. 9 is an image of a third user interface screen 900 for accessing a Web-based system for diagnosis of medical conditions or problems, the third user interface screen 900 including a name 950 of a possible diagnosis selected by the user, with a description 952 of symptoms associated with the diagnosis. Various functions may be selected with buttons arranged below the diagnosis name 950, such as a diagnosis description display button 951, a prevention description display button 960, a treatment description display button 961, an edit button 963 (to permit the user to edit diagnosis, prevention, and/or display information), and a save button 964. A user feedback dialog box 940 prompts the user to identify whether the diagnosis is correct, with a corresponding submit button 941. An identification 930 of multiple possible diagnoses 931A-931X is ranked according to probability of each respective diagnosis corresponding to the searched symptoms, with each possible diagnosis 931A-931X being presented with an associated correctness probability 932A-932X. Various contributors to the diagnosis description and/or diagnosis rule are listed in a contributors section 952, with identification of one expert user 953 represented as a hyperlink to permit search users to view a site or communication interface associated with the expert user, and with identification of one contributing user 954A including an associated advertisement 954A-1 of a website for a charity (e.g., www.unicef.org) displayed proximate to the name of the contributing user 954A. Various references relating to the diagnosis (such as may provide more information regarding description, treatment, and/or prevention) may be displayed within a references section 958. The third user interface screen 900 further includes a symptom entry dialog box 928 permitting a user to search for additional symptoms, a user name dialog box 901 permitting entry of a user name, a password dialog box 902 permitting entry of a password, a “log in” button 903, and a “back to search results” button 975.

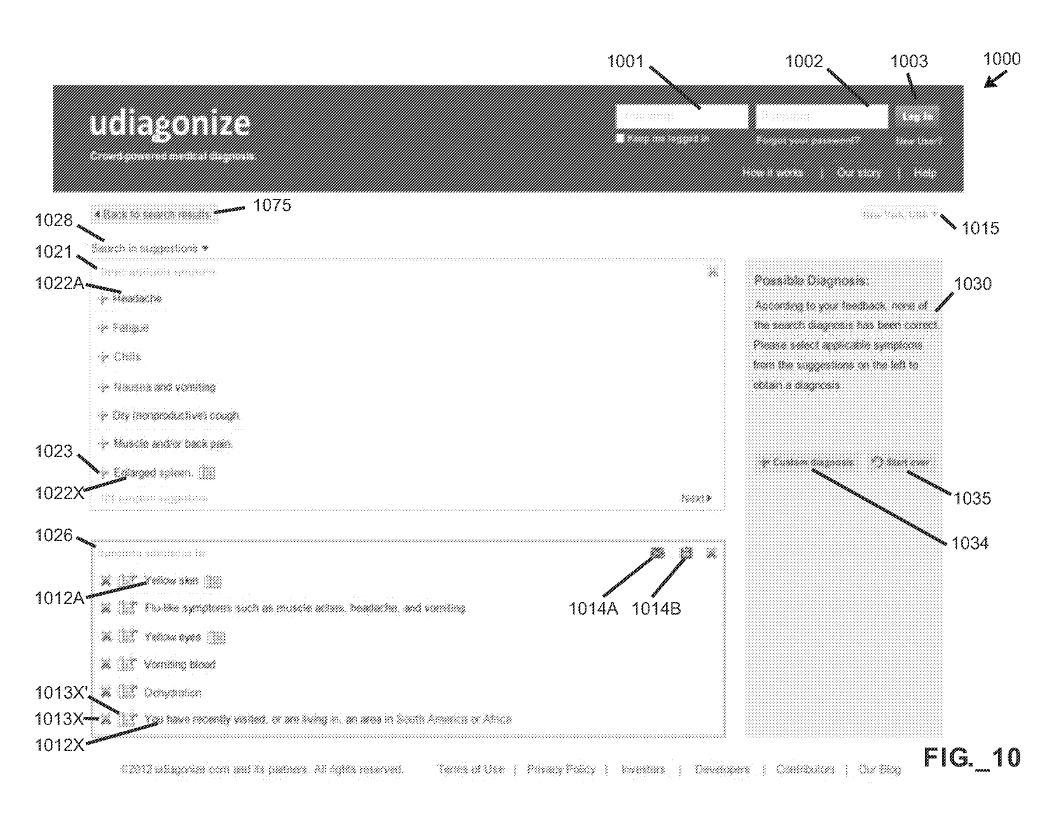

FIG. 10 is an image of a fourth user interface screen 1000 for accessing a Web-based system for diagnosis of medical conditions or problems, the fourth user interface screen 100 eliciting further input from the user following receipt of user feedback that the user did not perceive a previously presented possible diagnosis as being correct. A message box 1030 states that: “According to your feedback, none of the search diagnosis has been correct. Please select applicable symptoms from the suggestions to the left to obtain a diagnosis.” The message box 1030 further includes a “confirm diagnosis” button 1034 and a “start over” button 1035. The screen 1000 includes a listing 1026 of symptoms entered by the search user and searched so far (including symptoms 1012A-1012X, each including an associated add photo button 1013X′ to enable additional of a photo for the symptom, and each including a remove button 1013X to remove the symptom from the listing 1026), and a listing 1021 of suggested symptoms (each including an add button 1023 to move the symptom to the selected symptom list). A symptom search button 1028 permits a user to initiate a symptom search among the suggested symptoms. A “back to search results” button 1075 permits the user to return to previously obtained search results. The listing 1026 of symptoms entered thus far further includes an email button 1014A (e.g., permitting a user to email a listing of symptoms to another party) and a save button 1014B (e.g., permitting a user to save a list of symptoms entered thus far) according to an account accessible (e.g., online via the World Wide Web) via a username and password. The fourth user interface screen 1000 further includes a symptom entry dialog box 1028 permitting a user to search for additional symptoms, a user name dialog box 1001 permitting entry of a user name, a password dialog box 1002 permitting entry of a password, a “log in” button 1003, and a “back to search results” button 1075. The screen 1000 further includes a region or locale dialog box 1015 depicting (in this case) “New York, USA.”

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Various combinations and sub-combinations of the structures described herein are contemplated and will be apparent to a skilled person having knowledge of this disclosure. Any of the various features and elements as disclosed herein may be combined with one or more other disclosed features and elements unless indicated to the contrary herein. Correspondingly, the invention as hereinafter claimed is intended to be broadly construed and interpreted, as including all such variations, modifications and alternative embodiments, within its scope and including equivalents of the claims.

What is claimed is:

1. A system for diagnosing a condition or problem, the system comprising:
a communication interface for sending and receiving network messages; and
a control module coupled with the communication interface configured to:
collect and store electronic data from a search user seeking to obtain diagnosis of the condition or problem, wherein the electronic data includes information indicative of at least one symptom relating to the condition or problem and includes information indicative of geographic region or location of the search user;
apply stored diagnosis rules to the electronic data to identify at least one possible diagnosis of the condition or problem, wherein the stored diagnosis rules includes diagnosis rules generated from information contributed by any of (i) expert users and (ii) non-preselected contributing users, and wherein each diagnosis rule has associated therewith a diagnosis rule trust factor; and
communicate to the search user the identified at least one possible diagnosis of the condition or problem.

2. A system according to claim 1, wherein the control module comprises a learning engine configured to perform at least one of the following tasks: (i) infer diagnosis rules generated from information contributed by any of expert users and non-preselected contributing users; (ii) categorize diagnosis rules; (iii) adjust diagnosis rule trust factors associated with diagnosis rules; (iv) promote provisional diagnosis rules to confirmed diagnosis rules eligible for application to the electronic data to identify at least one possible diagnosis of the condition or problem; and (v) demote confirmed diagnosis rules to provisional diagnosis rules not eligible for application to the electronic data to identify at least one possible diagnosis of the condition or problem.

3. A system according to claim 1, wherein the control module is configured to elicit feedback from a search user via the communication interface, wherein the feedback is indicative of accuracy or perceived accuracy of the at least one possible diagnosis, wherein the control module is configured to adjust at least one diagnosis rule trust factor based on search user feedback regarding accuracy or perceived accuracy of diagnoses generated by applying the stored diagnosis rules, and to store the adjusted at least one diagnosis rule trust factor.

4. A system according to claim 1, wherein the control module is configured to access a first database including provisional diagnosis rules that are not eligible for application to the electronic data to identify at least one possible diagnosis of the condition or problem, and the control module is configured to access a second database including confirmed diagnosis rules that are eligible for application to the electronic data to identify at least one possible diagnosis of the condition or problem.

5. A system according to claim 1, wherein the control module is configured to:
receive, from a non-preselected contributing user, electronic data including information indicative of at least one symptom of a condition or problem, and indicative of a diagnosis of the condition or problem corresponding to the at least one symptom;
generate a new diagnosis rule based on the information received from the non-preselected contributing user;
associate a diagnosis rule trust factor with the new diagnosis rule; and
apply the new diagnosis rule in conjunction with the stored diagnosis rules to the electronic data collected from the search user to identify a plurality of possible diagnoses of the condition or problem.

6. A system according to claim 1, wherein the control module comprises a learning engine configured to:
analyze stored information contributed by any of contributing users and expert users, and
based on the analyzed information, perform any of the following: (i) generate new diagnosis rules, (ii) modify existing diagnosis rules, (iii) generate symptom descriptions, and (iv) modify existing symptom descriptions.

7. A system according to claim 1, wherein:
the condition or problem includes a disease; and
the control module is configured to identify trends of diagnosis results relating to the disease, and configured to report to at least one health authority information indicative of an increased temporal and/or geographic incidence of diagnosis results relating to the disease.

8. A system according to claim 1, wherein the condition or problem includes at least one of the following: a medical condition, a disease, a drug interaction, and a drug side effect.

9. A method for diagnosing a condition or problem, method comprising utilizing at least one computing device that includes at least one processor and at least one memory element, to perform steps comprising:
collecting and storing electronic data from a search user seeking to obtain diagnosis of the condition or problem, wherein the electronic data includes information indicative of at least one symptom relating to the condition or problem and includes information indicative of geographic region or location of the search user;
applying stored diagnosis rules to the electronic data to identify at least one possible diagnosis of the condition or problem, wherein the stored diagnosis rules includes diagnosis rules generated from information contributed by any of (i) expert users and (ii) non-preselected contributing users, and wherein each diagnosis rule has associated therewith a diagnosis rule trust factor; and
communicating to the search user the identified at least one possible diagnosis of the condition or problem.

10. A method according to claim 9, wherein said at least one possible diagnosis of the condition or problem comprises a plurality of possible diagnoses of the condition or problem, and wherein said communicating to the search user includes ranking possible diagnoses of the plurality of possible diagnoses based at least in part on diagnosis rule trust factors associated with the diagnosis rules used to identify the respective possible diagnoses.

11. A method according to claim 10, wherein said ranking of possible diagnoses is based in part on said information indicative of geographic region or location of the search user.

12. A method according to claim 9, further comprising eliciting feedback from the search user indicative of accuracy or perceived accuracy of the at least one possible diagnosis.

13. A method according to claim 9, further comprising adjusting at least one diagnosis rule trust factor based on search user feedback regarding accuracy or perceived accuracy of diagnoses generated by applying the stored diagnosis rules, and storing the adjusted at least one diagnosis rule trust factor in the at least one memory element.

14. A method according to claim 9, wherein said collecting of electronic data comprises:
presenting the search user with at least one demonstrative item representative of a symptom potentially related to the condition or problem, the demonstrative item comprising any of (i) a photographic image, (ii) a sound clip, (iii) a video clip, and (iv) a diagnostic scanning image; and
eliciting information from the search user indicative of at least one symptom of the condition or problem based on the search user's review of the at least one demonstrative item.

15. A method according to claim 9, wherein said collecting of electronic data comprises suggesting to a search user at least one potential additional symptom based on any one or more of: (i) electronic data collected from a search user indicative of at least one symptom relating to the condition or problem, (ii) information indicative of geographic region or location of the search user, (iii) at least one possible diagnosis previously communicated to the search user, and (iv) search user feedback based on at least one possible diagnosis communicated identified to the search user.

16. A method according to claim 9, further comprising, based on at least one possible diagnosis of the condition or problem identified to the search user, providing the search user with contact information for, or initiating communication by the search user with, any one or more of the following: (i) at least one expert user having expertise relating to the problem or condition, (ii) at least one provider of treatment or mitigation services relating to the problem or condition, and (iii) at least one provider of treatment or mitigation products relating to the problem or condition.

17. A method according to claim 9, further comprising:
receiving, from a non-preselected contributing user, electronic data including information indicative of at least one symptom of a condition or problem, and indicative of a diagnosis of the condition or problem corresponding to the at least one symptom;
generating a new diagnosis rule based on the information received from the non-preselected contributing user;
associating a diagnosis rule trust factor with the new diagnosis rule; and
applying the new diagnosis rule in conjunction with the stored diagnosis rules to the electronic data collected from the search user to identify a plurality of possible diagnoses of the condition or problem.

18. A method according to claim 9, wherein the condition or problem includes at least one of the following: a medical condition, a disease, a drug interaction, and a drug side effect.

19. A method according to claim 9, wherein the condition or problem includes a disease, and the method further comprises: identifying trends of diagnosis results relating to the disease, and reporting to at least one health authority information indicative of an increased temporal and/or geographic incidence of diagnosis results relating to the disease.

20. A method for diagnosing a condition or problem, method comprising utilizing at least one computing device that includes at least one processor and at least one memory element, to perform steps comprising:
collecting and storing electronic data from a search user seeking to obtain diagnosis of the condition or problem, wherein the electronic data includes information indicative of at least one symptom relating to the condition or problem and includes information indicative of geographic region or location of the search user;
applying stored diagnosis rules to the electronic data to identify a plurality of possible diagnoses of the condition or problem, wherein each diagnosis rule has associated therewith a diagnosis rule trust factor; and
communicating to the search user the plurality of possible diagnoses of the condition or problem, wherein such identifying includes ranking the possible diagnoses based at least in part on diagnosis rule trust factors associated with the diagnosis rules used to identify the respective possible diagnoses.
